(19) United States
(12) Patent Application Publication
(10) Pub. No.: US 2012/0173923 A1
(43) Pub. Date: Jul. 5, 2012

(54) ACCELERATING THE PERFORMANCE OF MATHEMATICAL FUNCTIONS IN HIGH PERFORMANCE COMPUTER SYSTEMS

(75) Inventors: Robert F. Enenkel, (US); Robert W. Hay, (US); Martin S. Schmookler, Austin, TX (US); Christopher K. Anand, (US)

(73) Assignee: INTERNATIONAL BUSINESS MACHINES CORPORATION, Armonk, NY (US)

(21) Appl. No.: 12/983,092

(22) Filed: Dec. 31, 2010

(51) Int. Cl. G06F 11/07; G06F 11/263

(52) U.S. Cl. 714/15; 714/E11.023; 714/E11.177

(57) ABSTRACT

Enabling application instructions to access mathematical functions from an accelerated function library to perform instructions. In the performance of the instructions, applying a predefined test instruction on a value, the value being at least one of an input argument, an intermediate result or a final result to determine if the value is a general-case or a predetermined special-case. Responsive to a determination that the value is a special-case, performing a predetermined set of special-case instructions for the performance of the mathematical function.

### TECHNICAL FIELD

The present invention relates to high performance computer systems, such as those involved in scientific computing and in complex financial applications involving the performance of mathematical functions.

### BACKGROUND OF RELATED ART

High performance computing is typically carried out in multiprocessing computer systems, involving multi cored processors operating on multi threaded application programs requiring the performance of mathematical functions. Because of this complexity, speed in operations essential. Accordingly, accelerated mathematical function libraries are provided to support the execution of application programming. These libraries, such as the International Business Machines Corporation (IBM): IBM™ Mathematical Acceleration SubSystem (MASS), provide mathematical functions that may be accessed as needed for the execution of mathematical functions required for the applications.

While operations involving mathematical function libraries have made great strides in accelerating the performance of mathematical functions in application algorithms, there remain application input arguments that involve mathematical functions that slow down the accelerated operations. Such special-case input arguments involve mathematical values such as zero (0), denormals, not-a-number (NaN) and for functions such as square root, negative number, as well as other input arguments that result in intermediate and final result values in an algorithm that cause the mathematical computations to overflow, underflow or otherwise lose accuracy. Current algorithms for handling such special-case values require transfers through memory between floating point (FP) registers and general purpose registers that delay accelerated performance of mathematical functions.

### SUMMARY OF THE PRESENT INVENTION

The present invention provides an implementation for acceleration of the performance of application instructions involving special-cases in mathematical functions by providing a library of mathematical functions, enabling application instructions to access mathematical functions from the library to perform instructions and performing such instructions, including mathematical functions. In the performance of the instructions, applying a predefined test instruction on a value, the value being at least one of an input argument, an intermediate result or a final result to determine if the value is a general-case or a predetermined special-case. In response to a determination that the value is a special-case, performing a predetermined set of special-case instructions for the performance of the mathematical function.

Irrespective of whether the input argument, intermediate result or final result is a special-case, the set of general-case instructions is still performed on the input argument, intermediate result or final result.

Then, if there is a general-case instruction set output failure, the general-case instruction set output may be overwritten with the output from the performance of the set of special-case instructions.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a processor that may be used in the performance of the mathematical function algorithms in accordance with the present invention;

FIG. 2 is a general flowchart of a program set up to implement the present invention for performance of mathematical functions; and

FIGS. 3A, B and C are a flowchart of an illustrative run of the program set up in FIG. 2.

### DETAILED DESCRIPTION OF THE PREFERRED EMBODIMENT

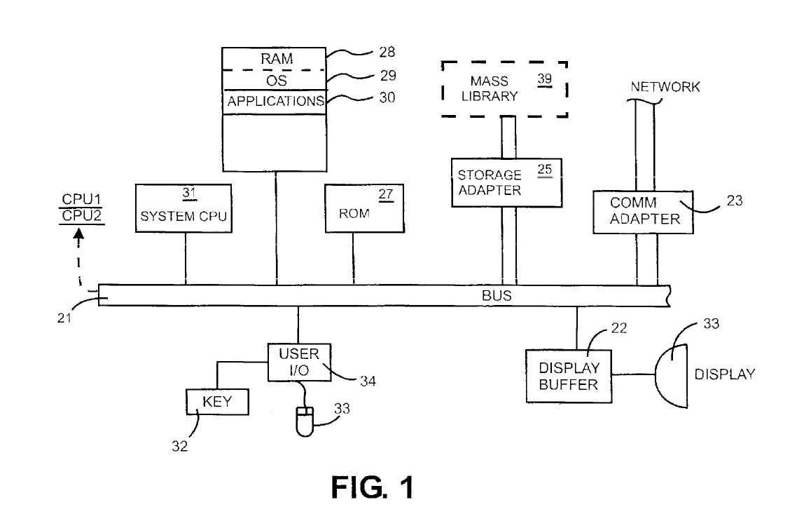

Referring to FIG. 1, there is shown a generalized diagrammatic view of a computer system embodiment on which algorithms, systems and methods of the present invention may be implemented. This illustrative example may be implemented in Power series, available from IBM, such Power7. The implementations to be described herein may be embodied in software (e.g. firmware), hardware or a combination of both. They may be carried out on special or general purpose computers, such as personal computers, workstations, minicomputers or mainframes.

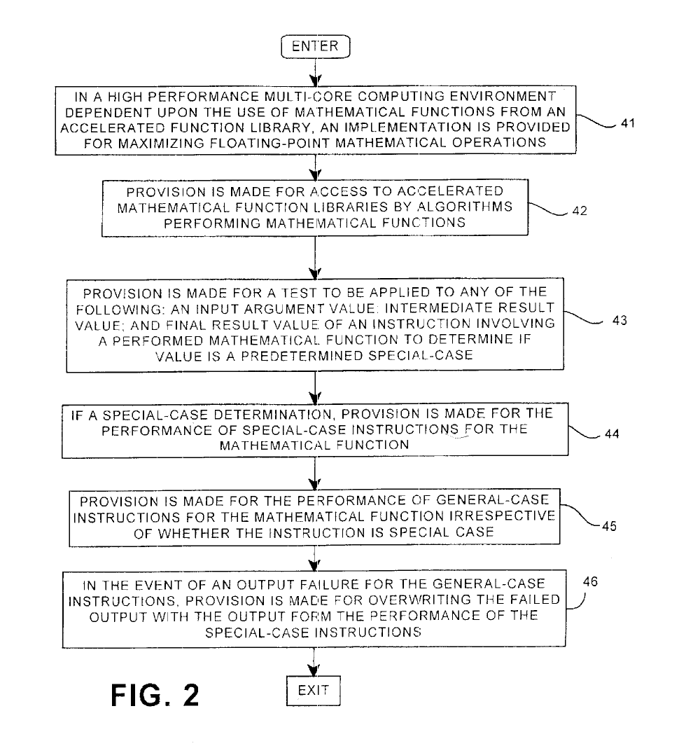

The system shown in FIG. 1 includes a central processing unit (CPU) 31, such as one of the microprocessors, e.g. from System p series available from IBM, which is interconnected to various other components by system bus 21. An operating system (OS) 29 runs on CPU 31, provides control and is used to coordinate the function of the various components of FIG. 2. Operating system 29 may be one of the commercially available operating systems. Application programs 30, controlled by the system, are moved into and out of the main memory Random Access Memory (RAM) 28. These programming applications may be used to implement functions of the present invention. ROM 27 includes the Basic Input/Output System (BIOS) that controls the basic computer functions of the CPU. RAM 28, storage adapter 25 and communications adapter 23 are also interconnected to system bus 21. Storage adapter 25 communicates with the disk storage device 26. The MASS Library 39, the use of which will be subsequently described in greater detail, may be stored in storage 26. Communications adapter 23 interconnects bus 21 with an outside Web or like network. I/O devices are also connected to system bus 21 via user interface adapter 34. I/O bus 21 is used to distribute program application threads being processed to multi core CPU1 and CPU2, under the control of system CPU 31. Optionally, keyboard 32 and mouse 33 may be connected to bus 21 through user interface adapter 34. When a display is used, display buffer 22 supports display 33.

FIG. 2 is a general flowchart of a program set up to implement the present invention for distinguishing special-cases in the performance of mathematical functions from general-cases using mathematical functions from MASS function libraries. The special-case situations usually involve FP operations, step 41.

Accordingly, there is a set-up for accessing accelerated system mathematical libraries by algorithms performing mathematical functions, step 42. Provision is made for a test (described hereinafter in greater detail) that will be applied to any or all of the following values while processing an algorithm: an input argument value, an intermediate result value and a final result value of an instruction involving a performed mathematical function to determine if there is a predetermined special-case, step 43. In the event of a value indicating a special-case, provision is made for the performance of special-case instructions for the mathematical function, step 44.

In any event, provision is made for the performance of the general-case instructions, irrespective of whether the instruction is a special-case, step 45. In the event of an output failure for the general-case instructions, provision is made for overwriting the failed output with the output from the performance of the special-case instructions, step 46.

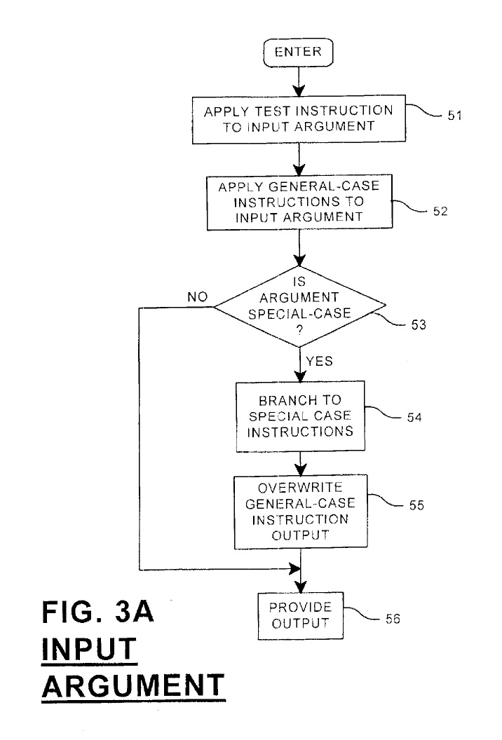

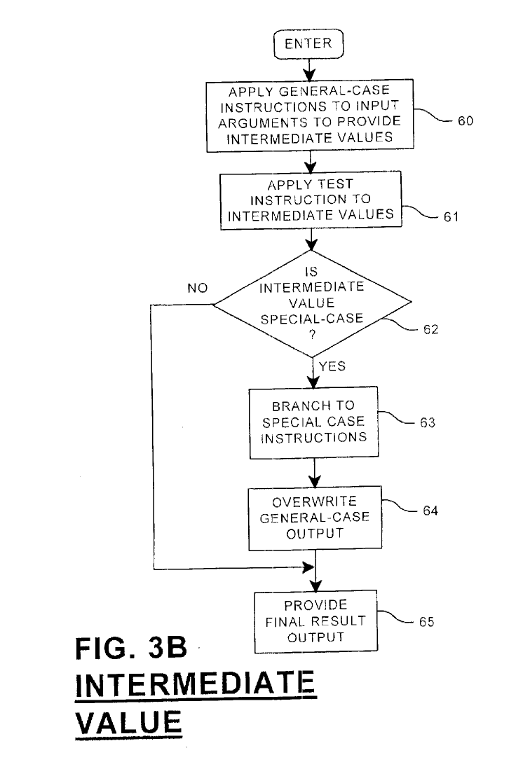

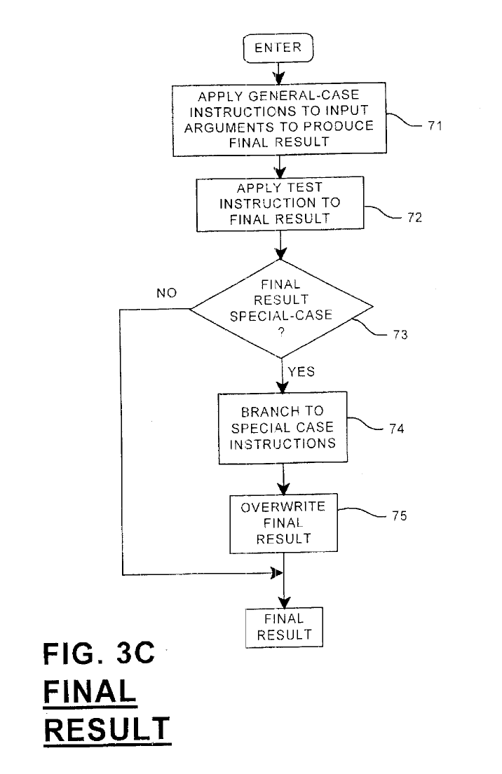

A simple illustrative example of a run of the process set up in FIG. 2 is described with respect to the flowcharts of FIGS. 3A, 3B and 3C. In this simplified example, the application of test instructions according to an aspect of the present invention will be described, as well as aspects of the invention involving input argument values, and intermediate and final result values in the performance of mathematical functions, may be special-case. The handling of such special-case situations will be described after the description of the illustrative flowchart of FIGS. 3A, 3B and 3C.

With respect to FIG. 3A, a test instruction is Applied to the input argument, step 51. Also, the general-case instructions are accessed from the MASS library and applied to the input argument, step 52. A determination is made as to whether the input argument value is a special-case, step 53. If Yes, a set of special-case instructions is branched to and applied to process the mathematical function, step 54, as will be subsequently described in detail. The result of the application of general-case instructions is overwritten with the result or output of the application of special-case instructions, step 55, to provide the output, step 56. If the determination in step 53 is No special-case, then the result of the application of general-case instructions would not be overwritten and provide the output of step 56. As a general alternative to this procedure, both the general-case and special-case instructions may be applied to the input argument and, dependent upon the test instruction result, e.g. an output failure for the general-case, the appropriate result is selected.

FIG. 3B covers a procedure for applying the test instruction to an intermediate result value. The general case instructions are accessed from the MASS library and applied to the input argument, step 60, to produce an intermediate value. A test instruction is applied to the intermediate value, step 61. A determination is made as to whether the intermediate value is a special-case, step 62. If Yes, a set of special-case instructions is branched to and applied to process the intermediate value, step 63, as will be subsequently described in detail. The result of the application of general-case instructions is overwritten with the result of the application of special-case instructions to provide the intermediate value, step 64 to provide the final result, step 65. If the determination in step 62 is No special-case, then the final result of the application of general-case instructions would not be overwritten and provides the output of step 65. Here again, as a general alternative to this procedure, both the general-case and special-case instructions may be applied to the input argument and, dependent upon the test instruction result, e.g. an output failure for the general-case, the appropriate result is selected.

FIG. 3C covers a procedure for applying the test instruction to a final result value. The general-case instructions are accessed from the MASS library and applied to the input argument, step 71, to produce a final result value. A test instruction is applied to the final result value, step 72. A determination is made as to whether the final result value is a special-case, step 73. If Yes, a set of special-case instructions is branched to and applied in the computing of the final result, step 74, as will be subsequently described in detail. The final result is overwritten with the result of the application of special-case instructions to provide the final result value, step 75. Here also, as a general alternative to this procedure, both the general-case and special-case instructions may be applied to the input argument and, dependent upon the test instruction result, e.g. an output failure for the general-case, the appropriate final result is selected.

Test Instructions; The following are illustrative examples of test instructions that may be used in the embodiments of this invention. The examples may conveniently be implemented on the IBM PowerPC architecture that specifies that FP unit has 32 FP registers (FPRs). All FP source operands are read from and all results are written into these registers that can be accessed quickly. Extra registers, scratch registers, can only be accessed by microcode. Each processed application thread has its own set of registers. In the processing of mathematical functions involving, a division or square root, an initial step involves reading a value, from a look-up table that is indexed with the b operand (FEB). The division look-up table involves a reciprocal estimate (1/FEB) and the square root look-up table holds a reciprocal square root value [1/(square root of FEB)]. The architecture provides both a single precision (fdivs) and a double precision (fdiv) FP division instruction, as well as both a single precision (fsqrts) and a double precision (fsqrt) square root instruction.

With respect to the present test instructions, test instructions are provided for single and double precision division and square root. Each test instruction specifies one of eight (8) available condition code (CC) fields in the condition register (CR) that is set to determine whether or not the input operands require handling as a special-case. This allows up to eight (8) software division or square root executions to be active at a time, with each using a different CC in the CR.

Each CC field contains four (4) bits, but the present test instructions may only set three (3) of the four (4) bits, i.e. the LT, GT and EQ bits. The LT bit is set to one (1) if the hardware reciprocal estimate instructions provide at least 14 bits of precision. Each test instruction also sets two (2) other bits related to the different sets of conditions tested as follows:

for a divide test instruction x/y,

CT bit is set to one (1) if x is infinity, or y is zero (0), infinity or denormal,

EQ bit is set to one (1) if x is NaN, or infinity, or y is zero (0), NaN, or infinity.

(It should be noted that there may be several other conditions, not considered here, wherein the exponents of x and y may cause underflow, overflow or loss of accuracy in typical Newton iteration code.)

for a square root test instruction with input x,

GT bit is set to one (1) if x is zero (0), infinity, or denormal,

EQ bit is set to one (1) if x is zero (0), NaN, infinity, or negative.

It should be noted that in addition to being usable on such FP functions as reciprocal, divide and square root, the test algorithms may be used with mathematical functions that do not use divide or square root internally but still need to detect exceptional case values. One example of this would be when a fast algorithm produces a zero (0) result, it may be necessary to check for conditions under which the sign of zero (0) may not match a specification.

It has been previously described that the test instructions of this invention may be applied in three (3) exemplary instances in the carrying out of a mathematical function: the value of an input argument; the value of an intermediate result; and the value of the final result. The following are examples of each.

Test Instruction Applied Directly on Input Argument:

For a divide and square root function:

Apply the test instruction to input argument(s),

Compute the general-case algorithm (that produces the incorrect result in a special-case),

If there is a special-case trigger, perform a conditional branch to a fixed hardware instruction for performing division or square root, and branch back to the next instruction.

Thus, the algorithm proceeds without delay with the higher throughput general-case algorithm and only invokes the lower throughput hardware divide or square root instruction in the rarer cases where the general-case algorithm fails.

It should be noted here that in table-based mathematical function algorithms, the table is typically indexed by an integer key determined by the input argument. Thus, when special-case handling requires a modification to the key to look up another table or differently into the same table, an isel (integer select) instruction fed by the test instruction can select one (1) of two (2) alternate keys.

Test Instruction to an Intermediate Result:

In the performance of iterative computations in mathematical functions, a result that should otherwise be correct will produce a NaN result in the case where the correct result should be zero (0) or infinity. Examples of such computations involve the Newton iteration for square root or reciprocal square root.

For example: sqrt(x) can be computed as x*t, where t is an approximation to 1/sqrt(x). The value t is obtained from an estimate instruction that may use a look-up table to provide the approximation. In the case where x=0 or infinity, x*t=0*Infinity=NaN that causes the result to become NaN instead of the correct result x. In this case, the test instruction may be applied to the intermediate result x*t to detect a NaN and, in this case, the value of the input x can be selected instead of the result x*t from the algorithm.

Test Instruction to a Final Result

There are circumstances when intermediate computations overflow or underflow even though the true answer is finite. This often occurs in computations involving division because there are denormalized numbers, the reciprocals of which are not representable. Such divisions occur, for example, in the rational polynomial approximations that are often used in mathematical function algorithms. In these cases, it can be more efficient to generate the results including the unwanted NaNs and infinities and test the result. Then based upon the result, the algorithm may perform a conditional branch to fix-up code or just record the problem and overwrite the problem in a clean-up loop. The conditional branch invoking fixup code may recompute the result in a branch to special-case hardware instructions as described above.

The following is one illustrative embodiment in code for an example wherein a test instruction is used in a group of four (4) software divides. All the divisions are single precision (SP) and may only provide 22 bits of precision rather than the 24 bits required to be correctly rounded per the industry standard (IEEE 754). The notation used for operands is v(i), where i=0, 1, 2 or 3 corresponds to one (1) of the four (4) software divides. Similar notation is used for the division test and branch instructions. Thus, the four (4) divides calculate q(0)=x(0)/y(0), q(1)=x(1)/y(1), q(2)=x(2)/y(2), and q(3)=x(3)/y(3).

divtest(0) of x(0), y(0), sets CC field 0 in CR

divtest(1) of x(1), y(1), sets CC field 1 in CR

divtest(2) of x(2), y(2), sets CC field 2 in CR

divtest(3) of x(3), y(3), sets CC field 3 in CR

t(0)=1/y(0)—Reciprocal estimate instruction with

t(1)=1/y(1) 14 bit precision.

t(2)=1/y(2)

t(3)=1/y(3)

q(0)=x(0)*t(0)—quotient with 14 bit precision

q(0)=x(1)*t(1)

q(2)=x(2)*t(2)

q(3)=x(3)*t(3)

e(0)=1−y(0)*t(0)—error [e(0)]<2̂-14

e(0)=1−y(1)*t(1)

e(0)=1−y(2)*t(2)

e(0)=1−y(3)*t(3)

q(0)=q(0)+q(0)*e(0)—quotient w 22 bit precision

branch to fixup(0) if GT(0)=1—if branch, return to

q(1)=q(1)+q(1)*e(1) next instruction

branch to fixup(1) if GT(1)=1

q(2)=q(2)+q(2)*e(2)

branch to fixup(2) if GT(2)=1

q(3)=q(3)+q(3)*e(3)

branch to fixup(3) if GT(3)=1

The branch instructions are predicted not to branch, since this is the case for almost all data. The branch instructions are executed in parallel with the general instructions. In the rare case when the special-case branch is taken, a corresponding hardware divide instruction overwrites the quotient result from the general-case computation.

As will be appreciated by one skilled in the art, aspects of the present invention may be embodied as a system, method or computer program product. Accordingly, aspects of the present invention may take the form of an entirely hardware embodiment, an entirely software embodiment, including firmware, resident software, micro-code, etc.; or an embodiment combining software and hardware aspects that may all generally be referred to herein as a “circuit”, “module” or “system.” Furthermore, aspects of the present invention may take the form of a computer program product embodied in one or more computer readable mediums having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared or semiconductor system, apparatus or device, or any suitable combination of the foregoing. More specific examples (a non-exhaustive list) of the computer readable storage medium would include the following: an electrical connection having one or more wires, a portable computer diskette, a hard disk, a Random Access Memory (“RAM”), a Read Only Memory (“ROM”), an Erasable Programmable Read Only Memory (“EPROM” or Flash memory), an optical fiber, a portable compact disc read only memory (“CD-ROM”), an optical storage device, a magnetic storage device or any suitable combination of the foregoing. In the comtext of this document, a computer readable storage medium may be any tangible medium that can contain or store a program for use by or in connection with an instruction execution system, apparatus or device.

A computer readable medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including, but not limited to, wireless, wire line, optical fiber cable, RF, etc., or any suitable combination the foregoing.

Computer program code for carrying out operations for aspects of the present invention may be written in any combination of one or more programming languages, including an object oriented programming language, such as Java, Smalltalk, C++ and the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the later scenario, the remote computer may be connected to the user's computer through any type of network, including a local area network (“LAN”) or a wide area network (“WAN”), or the connection may be made to an external computer (for example, through the Internet, using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer or other programmable data processing apparatus to produce a machine, such that instructions, which execute via the processor of the computer or other programmable data processing apparatus, create means for implementing the functions/acts specified flowchart and/or block diagram block or blocks.

These computer program instructions may also be stored in a computer readable medium that can direct a computer, other programmable data processing apparatus or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagram in the Figures illustrate the architecture, functionality and operations of possible implementations of systems, methods and computer program products according to various embodiments of the present invention. In this regard, each block in the flowchart or block diagrams may represent a module segment, or portion of code, which comprises one or more executable instructions for implementing the specified logical function(s). It should be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations can be implemented by special purpose hardware-based systems that perform the specified functions or acts, or combinations of special purpose hardware and computer instructions.

Although certain preferred embodiments have been shown and described, it will be understood that many changes and modifications may be made therein without departing from the scope and intent of the appended claims.

What is claimed is:

1. A method for acceleration of the performance of application instructions involving mathematical functions in high performance computing comprising:
providing a library of mathematical functions;
enabling application instructions to access mathematical functions from said library to perform instructions;
performing instructions including said mathematical functions;
in said performance of said instructions, applying a predefined test instruction on a value, said value being at least one of an input argument, an intermediate result or a final result to determine if said value is a general-case or a predetermined special-case;
responsive to a determination that said value is a special-case, performing a predetermined set of special-case instructions for the performance of the mathematical function;
performing a set of general-case instructions on said input argument, intermediate result or final result, irrespective of whether said input argument, intermediate result or final result is a special-case; and
in the event of a general-case instruction set output failure, overwriting the general-case instruction set output with the output from the performance of said set of special-case instructions.

2. The method of claim 1, wherein:
said predefined test instruction is applied to an input argument; and
responsive to a determination that input argument is a special-case, continuing to perform said general-case instructions on said input argument while said special-case instructions are being performed.

3. The method of claim 1, wherein:
said predefined test instruction is applied to an intermediate result; and
said test instruction determines whether said result is a NaN or infinity.

4. The method of claim 1, comprising:
performing the general-case instructions to provide a final result;
performing said test instruction on said final result to determine whether the final result argument includes a NaN or an infinity;
responsive to a determination that said final result includes a NaN or an infinity, performing said special-case instructions; and
overwriting the general-case instruction result with the result from the performance of said set of special-case instructions.

5. The method of claim 1, wherein responsive to a determination that an input argument value, an intermediate result value or a final result value is a special-case, the method is branched to a predetermined set of special-case hardware instructions for the performance of the mathematical function.

6. The method of claim 1, wherein:
responsive to a determination that said input argument value, an intermediate result value, or a final result value is a special-case, the method is branched to a predetermined set of special-case instructions including a lookup table changing instruction performed by integer select (isel).

7. The method of claim 1 wherein, responsive to a determination that a value is special-case, an output failure is assumed and the general-case instruction set output is overwritten with the output from the performance of said set of special-case instructions.

8. A system for acceleration of the performance of application instructions involving mathematical functions in high performance computing, said system comprising:
a processor; and
a computer memory holding computer program instructions that, when executed by the processor, perform the method comprising:
providing a library of mathematical functions;
enabling application instructions to access mathematical functions from said library to perform instructions;
performing instructions including said mathematical functions;
in said performance of said instructions, applying a predefined test instruction on a value, said value being at least one of an input argument, an intermediate result or a final result to determine if said value is a general-case or a predetermined special-case;
responsive to a determination that said value is a special-case, performing a predetermined set of special-case instructions for the performance of the mathematical function;
performing a set of general-case instructions on said input argument, intermediate result, or final result, irrespective of whether said input argument, intermediate result, or final result is a special-case; and
in the event of a general-case instruction set output failure, overwriting the general-case instruction set output with the output from the performance of said set of special-case instructions.

9. The system of claim 8, wherein:
said predefined test instruction is applied to an input argument; and
responsive to a determination that input argument is a special-case, the performed method continues to perform said general-case instructions on said input argument while said special-case instructions are being performed.

10. The system of claim 8, wherein:
said performed method applies said predefined test instruction to an intermediate result; and
said test instruction determines whether said result is a NaN or infinity.

11. The system of claim 8, wherein the performed method comprises:
performing the general-case instructions to provide a final result;
performing said test instruction on said final result to determine whether final result includes a NaN or an infinity;
responsive to a determination that said final result includes a NaN or an infinity, performing said special-case instructions; and
then overwriting the general-case instruction output with the output from the performance of said set of special-case instructions.

12. The system of claim 8, wherein responsive to a determination that an input argument value, an intermediate result value or a final result value is a special-case, the performed method branches to a predetermined set of special-case hardware instructions for the performance of the mathematical function.

13. The system of claim 8, wherein:
responsive to a determination that an input argument value, an intermediate result value or a final result value is a special-case, the performed method branches to a predetermined set of special-case instructions including a lookup table changing instruction performed by integer select (isel).

14. The system of claim 8, wherein responsive to a determination that a value is special-case, an output failure is assumed and the general-case instruction set output is overwritten with the output from the performance of said set of special-case instructions.

15. A computer usable storage medium having stored thereon a computer readable program for acceleration of the performance of application instructions involving mathematical functions in high performance computing, wherein the computer readable program when executed on a computer causes the computer to:
provide a library of mathematical functions;
enable application instructions to access mathematical functions from said library to perform instructions;
perform instructions including said mathematical functions;
in said performance of said instructions, apply a predefined test instruction on a value, said value being at least one of an input argument, an intermediate result or a final result to determine if said value is a general-case or a predetermined special-case;
responsive to a determination that said value is a special-case, perform a predetermined set of special-case instructions for the performance of the mathematical function;
perform a set of general-case instructions on said input argument, intermediate result, or final result, irrespective of whether said input argument, intermediate result or final result is a special-case; and
in the event of a general-case instruction set output failure, overwrite the general-case instruction set output with the output from the performance of said set of special-case instructions.

16. The computer usable storage medium of claim 15, wherein the computer program, when executed on a computer, causes the computer to:
apply said predefined test instruction to an input argument; and
responsive to a determination that the input argument is a special-case, continue to perform said general-case instructions on said input argument while said special-case instructions are being performed.

17. The computer usable storage medium of claim 15, wherein:
said predefined test instruction is applied to an intermediate result; and
said test instruction determines whether said result is a NaN or infinity.

18. The computer usable storage medium of claim 15, wherein the computer program, when executed on a computer, causes the computer to:
perform the general-case instructions to provide a final result;
perform said test instruction on said final result to determine whether the final result argument includes a NaN or an infinity;
responsive to a determination that said final result argument includes a NaN or an infinity, perform said special-case instructions; and
overwrite the general-case instruction output with the output from the performance of said set of special-case instructions.

19. The computer usable storage medium of claim 15, wherein responsive to a determination that an input argument value, an intermediate result value or a final result value is a special-case, the computer program causes the computer to branch to a predetermined set of special-case hardware instructions for the performance of the mathematical function.

20. The computer usable storage medium of claim 15, wherein:
responsive to a determination that an input argument value, an intermediate result value or a final result value is a special-case, the computer program causes the computer to branch to a predetermined set of special-case instructions, including a look-up table changing instruction performed by integer select (isel).

21. The computer usable storage medium of claim 15, wherein responsive to a determination that a value is special-case, an output failure is assumed and the general-case instruction set output is overwritten with the output from the performance of said set of special-case instructions.
